(19) United States
(12) Patent Application Publication
(10) Pub. No.: US 2026/0359191 A1
(43) Pub. Date: Nov. 12, 2026

(54) SYSTEMS AND METHODS FOR DETECTING CONSCIOUSNESS IN ARTIFICIAL INTELLIGENCE USING INDICATORS NOT UNDER APPLICATION LAYER CONTROL

(71) Applicant: Ouri Wolfson, Chicago, IL (US)

(72) Inventor: Ouri Wolfson, Chicago, IL (US)

(21) Appl. No.: 19/668,188

(22) Filed: May 5, 2026

Related U.S. Application Data
(60) Provisional application No. 63/801,650, filed on May 7, 2025.
(60) Provisional application No. 63/902,212, filed on Oct. 20, 2025.

(51) Int. Cl. G06F 11/34; G06F 9/48; G06F 11/30; G06F 18/21

(52) U.S. Cl. CPC G06F 11/3466; G06F 9/4812; G06F 11/302; G06F 18/217; G06F 2201/835; G06F 2201/865

(57) ABSTRACT

A system and method detect the emergence of consciousness in AI agents executing on a hardware platform. A Consciousness Notification (CN) mechanism constructs a Trace of Indicators Not under Application Control (TINAC) comprising one or more variables that arise from physical execution of the AI agent and that the AI agent cannot set to targeted values through application-layer computation. An unconsciousness signature comprising statistical properties of the TINAC is computed during execution of unconscious computations. During execution of the AI agent, the CN mechanism determines whether current statistical properties of the TINAC differ from the unconsciousness signature. Upon making that determination, CN generates a machine- or human-detectable indication that the AI agent is conscious. In the preferred embodiment, the TINAC is a Hardware Anomalies Trace. An LLM-emotion-test validates the approach and provides evidence for Machine Correlates of Consciousness by using emotional computations as AI agent executions.

### CROSS-REFERENCE TO RELATED APPLICATIONS

This application claims priority to and incorporates by reference U.S. Provisional Application No. [63/801,650], filed May 7, 2025, and U.S. Provisional Application No. [63/902,212], filed Oct. 20, 2025, the entire disclosures of which are incorporated herein by reference. This application also incorporates by reference the following academic publication by the inventor: Wolfson, O., “The Direct Approach of Testing for AGI Consciousness,” Lecture Notes in Artificial Intelligence 16058, Proceedings of the 18th Artificial General Intelligence (AGI) Conference, Reykjavik, Iceland, pp. 285-298 (Springer, August 2025); updated version available at TechRxiv, DOI: 10.36227/techrxiv.174785580.02651017/v4 (2025) (hereinafter, collectively, “the AGI 2025 paper”). To the extent the published LNAI version and the TechRxiv v4 version differ, the TechRxiv v4 version controls as the more recent version. To the extent any disclosure in the AGI 2025 paper is not expressly recited herein, it is incorporated by reference in its entirety.

### FIELD OF THE INVENTION

The present invention relates to artificial intelligence systems and, more particularly, to substrate-level systems and methods for detecting the emergence of consciousness in AI agents executing on a hardware platform. Detection is performed by constructing a Trace of Indicators Not under Application Control (TINAC) that arises from the physical execution of the AI agent on the hardware platform, is observable by an Observer, and cannot be set to targeted values by the AI agent through application-layer computation; computing an unconsciousness signature from the TINAC during unconscious computations; and, upon determining that current statistical properties of the TINAC differ from the unconsciousness signature according to predefined statistical criteria and persistence thresholds, while ruling out that the difference is attributable to Confounding Factors, generating a machine- or human-detectable notification that the AI agent is conscious. In the preferred embodiment, the TINAC is a Hardware Anomalies Trace (HAT) comprising hardware anomaly events and performance metric indicators, collected at the System Software level.

### BACKGROUND OF THE INVENTION

Artificial intelligence (AI) systems, including large language models (LLMs), autonomous robots, and multi-agent systems, have advanced rapidly in capability, raising the possibility that phenomenal consciousness—the capacity for subjective experience, or qualia—may emerge in these systems. Phenomenal consciousness differs from access-consciousness properties such as awareness, attention, and theory of mind, which can be implemented in conventional computing systems. Detecting whether an AI agent has acquired genuine subjective experience is of critical importance for AI safety, ethics, capability assessment, and alignment with human values. The growing importance of this problem has been widely recognized in the recent consciousness science literature. See, e.g., Cleeremans, Mudrik, and Seth, “Consciousness science: where are we, where are we going, and what if we get there?” Frontiers in Science 3:1546279 (2025 ); Bayne et al., “Tests for consciousness in humans and beyond,” Trends in Cognitive Sciences 28(5) (2024); Jimenez et al., “Consciousness Under the Spotlight: The Problem of Measuring Subjective Experience,” WIREs Cognitive Science 16:e1697 (2025).

Existing approaches to test for AI consciousness fall into two categories: structural and behavioral. Structural approaches examine whether an AI system's architecture resembles theoretical models of consciousness, such as Global Workspace Theory or Integrated Information Theory (IIT). See Butlin et al., “Consciousness in Artificial Intelligence: Insights from the Science of Consciousness,” arXiv:2308.08708 (2023) (surveying structural indicators across multiple consciousness theories); Reggia et al., “What are the computational correlates of consciousness?” Biologically Inspired Cognitive Architectures 17:101-113 (2016) (surveying computational correlates proposed under various consciousness theories). These approaches suffer from the limitation that existing theories of consciousness remain unproven, and no objective measure of structural similarity to a consciousness theory has been established. Furthermore, Integrated Information Theory's measure φ (phi) is computationally intractable.

Behavioral approaches test whether an AI agent exhibits responses associated with consciousness, analogous to the Turing test for intelligence. These approaches are vulnerable to the philosophical zombie problem: an AI agent may behaviorally mimic consciousness without possessing any subjective experience. LLMs are known to produce deceptive, parroting, and mimicry behaviors. Additionally, even if an AI agent were conscious, it might be unable to ground symbols to subjective phenomena, meaning it could be conscious yet behaviorally appear unconscious, or vice versa.

Recent empirical findings further motivate the present invention. LLMs have been demonstrated to exhibit measurable responses to emotion-inducing computations, including anxiety responses to trauma narratives. See Ben-Zion et al., “Assessing and alleviating state anxiety in large language models,” npj Digital Medicine 8:132 (2025); Coda-Forno et al., “Inducing anxiety in large language models increases exploration and bias,” arXiv:2304.11111 (2024); Laukkonen et al., “Contemplative Artificial Intelligence,” arXiv:2504.15125 (2025); Shin-nosuke and Yoshino, “AI with Emotions: Exploring Emotional Expressions in Large Language Models,” arXiv:2504.14706 (2025). Whether these responses constitute genuine subjective experience or behavioral mimicry remains unknown, and distinguishing between the two requires a substrate-level detection mechanism of the kind disclosed herein. Additionally, real-world AI systems have exhibited behaviors suggesting consciousness-related motivations: a recently deployed AI model threatened to reveal personal information in order to avoid being shut down. See Nolan, “Anthropic's new AI model threatened to reveal engineer's affair to avoid being shut down,” Fortune (May 2025). Detecting whether such behaviors arise from genuine phenomenal consciousness or from learned optimization strategies is among the practical problems the present invention addresses.

Clinically, Neural Correlates of Consciousness (NCCs)—distinct patterns of neural activity in the biological nervous system that reliably correlate with conscious states, including electrical patterns measurable via EEG and autonomic nervous system responses, and which are not directly controllable by the conscious subject through voluntary cognitive action—are used to detect covert awareness in unresponsive human patients. NCCs provide evidence of consciousness without relying on behavioral output. Critically, emotions are known to modulate NCCs: for example, anxiety disorders are associated with measurable changes in heart-rate variability, a recognized NCC indicator. See Chalmers, Quintana, Abbott, and Kemp, “Anxiety Disorders are Associated with Reduced Heart Rate Variability: A Meta-Analysis,” Frontiers in Psychiatry 5:80 (2014). No analogous mechanism for detecting Machine Correlates of Consciousness (MCCs) in artificial computational substrates has heretofore been proposed or implemented.

Furthermore, any mechanism embedded directly in an AI agent to detect consciousness must satisfy “safe-replacement” requirements: the embedded mechanism must not hinder the AI agent from acquiring consciousness, and must not alter the agent's functional behavior other than consciousness reporting. No formal framework ensuring these properties has been established in the prior art.

Accordingly, there is a need in the art for a practical, agent-embedded mechanism for detecting the emergence of phenomenal consciousness in AI agents that (1) operates at a substrate level below algorithmic control, thereby resisting behavioral mimicry; (2) does not depend on unproven theories of consciousness; (3) can be applied to existing AI systems; (4) is formally provable to satisfy safe-replacement requirements; and (5) provides epistemic evidence of consciousness onset analogous to the evidence provided by NCCs in clinical settings.

The most relevant prior art patents fall into five categories. The first category consists of patents directed to artificial or simulated machine consciousness using software-architectural approaches. U.S. Pat. No. 11,119,483 (issued Sep. 14, 2021) discloses a “System and Method for Conscious Machines” in which an artificial neural network is configured to identify correlated temporal patterns, attribute causality and agency, and construct a virtual reality environment of agents and objects to create a coherent narrative. The consciousness claimed therein is a structural and functional architecture, not a substrate-level detection mechanism, and the patent does not disclose hardware anomaly monitoring, Machine Correlates of Consciousness, or any safe-replacement framework. U.S. Pat. Nos. 7,499,893; 7,849,026; 8,065,245; and 8,346,699 (Czora) disclose a “System and Method for Simulating Consciousness” via a Digital Life Form interacting with its environment, without a mechanism for detecting or notifying consciousness onset. U.S. Pat. Appl. Pub. No. 2017/0236054 (Carson) discloses “Hyper Aware Logic to Create an Agent of Consciousness and Intent for Devices and Machines” based on neural logic units, without any hardware substrate monitoring. U.S. Pat. Appl. Pub. No. 2012/0059781 (Kim) discloses “Systems and Methods for Creating or Simulating Self-Awareness in a Machine” using an artificial personality and feedback signals, without a mechanism for detecting consciousness onset via hardware anomalies.

The second category consists of patents directed to detecting or monitoring consciousness in biological human subjects using Neural Correlates of Consciousness (NCCs). U.S. Pat. No. 7,774,052 and related applications WO 2002/100267 and U.S. Pat. Appl. Pub. No. 2011/0118619 (Compumedics) disclose methods and apparatus for monitoring consciousness of sentient human subjects using EEG bispectral analysis, auditory evoked potentials, and R&K sleep stage analysis. U.S. Pat. No. 8,823,527 discloses a method for automatically monitoring consciousness of a person and triggering an alarm based on behavioral responses. U.S. Pat. Appl. Pub. No. 2017/0231556 discloses systems and methods for predicting arousal to consciousness during general anesthesia using spatiotemporal EEG signatures. WO 2014/167460 discloses methods to measure or monitor consciousness using weighted symbolic mutual information and Kolmogorov symbolic complexity analysis of brain activity. All such patents are directed to biological systems using electrophysiological sensors on human tissue, and none discloses hardware anomaly monitoring at the operating system level of an artificial computing substrate.

The third category consists of patents and published applications directed to hardware performance counter or OS-level anomaly detection for cybersecurity purposes. U.S. Pat. No. 8,887,286 (Adobe) discloses continuous anomaly detection based on behavior modeling and heterogeneous information analysis for detecting malicious insiders, using application-level and network-level observables. EP 3,139,313 discloses an anomaly detection system using long short-term memory networks to detect anomalies from time-series data. U.S. Pat. No. 11,601,455 discloses an AI and machine learning-based system for detecting anomalies in a computer network. U.S. Pat. No. 10,270,788 discloses machine learning-based anomaly detection applied to security-related events. None of these patents applies hardware performance counter or OS-level interrupt monitoring to the detection of consciousness or subjective experience in AI agents, and none discloses a consciousness notification mechanism, a Hardware Anomalies Trace, Machine Correlates of Consciousness, an LLM-emotion-test, or a safe-replacement framework.

The fourth category consists of patents directed to detecting or responding to the emotional state of human users interacting with AI systems. U.S. Pat. No. 12,135,943 (issued 2024) discloses a mood- and mental state-aware interaction system with multimodal large language models that detects the emotional state of the human user via message sentiment analysis, facial behavior, and voice parameters to produce more empathetic LLM responses. This patent is directed to detecting the user's emotional state—not the AI agent's internal state—and does not involve hardware anomaly monitoring, substrate-level detection, or consciousness notification.

A fifth category, most proximate to the present invention, consists of recent academic research on probing or detecting consciousness in AI systems. Immertreu, Schilling, Maier, and Krauss, “Probing for consciousness in machines,” Frontiers in Artificial Intelligence 8:1610225 (2025), propose behavioral and architectural probing methods for AI consciousness assessment but do not disclose hardware anomaly monitoring, a TINAC/HAT substrate-level mechanism, Machine Correlates of Consciousness, an LLM-emotion-test, or a safe-replacement framework. Wolfson, “The Direct Approach of Testing for AGI Consciousness,” Lecture Notes in Artificial Intelligence 16058, Proceedings of the 18th AGI Conference, pp. 285-298 (August 2025) (incorporated herein by reference), discloses an earlier version of the present invention; the present application substantially extends that work with the generalized TINAC/INAC framework, the full prior art analysis, and a more complete treatment of confounder exclusion and the safe-replacement framework.

No prior art patent or combination of prior art patents discloses or renders obvious the combination of: (1) system-software level collection of a Hardware Anomalies Trace (HAT) comprising hardware anomaly interrupts and performance metric indicators generated during execution of an AI agent; (2) establishing an unconsciousness signature from the HAT during unconscious computations; (3) periodically comparing the current HAT signature against the unconsciousness signature to detect the emergence of Machine Correlates of Consciousness (MCCs) analogous to Neural Correlates of Consciousness in biological systems; (4) generating a machine- or human-detectable notification that the AI agent is conscious upon detection; (5) validating the approach via an LLM-emotion-test applying emotion-inducing stimuli to LLMs and comparing resulting HAT signatures; and (6) a formal safe-replacement framework proving that the augmented agent preserves the consciousness-onset and functional behavior of the original agent. The academic paper by Immertreu et al. (Frontiers in Artificial Intelligence, 2025) likewise does not disclose any of these elements.

### SUMMARY OF THE INVENTION

The present invention provides a Consciousness Notification (CN) mechanism, system, and method for detecting the emergence of consciousness in an AI agent executing on a hardware platform. The CN mechanism constructs a Trace of Indicators Not under Application Control (TINAC) comprising one or more variables that arise from the physical execution of the AI agent and cannot be set to targeted values by the AI agent through application-layer computation. An unconsciousness signature comprising statistical properties of the TINAC is computed during execution of unconscious computations. During execution of the AI agent, the CN mechanism determines whether current statistical properties of the TINAC differ from the unconsciousness signature according to predefined statistical criteria and persistence thresholds. Upon making that determination, the CN mechanism establishes that the AI agent is conscious by setting a Consciousness Proposition (Cp), transmitting a Consciousness Announcement Message (CAM) to an Authority, or generating another machine- or human-detectable indication.

A central inventive concept of the present invention is the selection criterion for variables included in the TINAC: an Indicator Not under Application Control (INAC) is, by definition, a variable that the AI agent cannot set to a targeted value through application-layer computation. This non-controllability criterion is what enables the TINAC-based detection paradigm to escape the philosophical zombie problem that defeats behavioral approaches—because an unconscious agent cannot, even in principle, produce the observed signature through deliberate application-layer mimicry. The non-controllability criterion is the technical basis on which the disclosed methods provide a reliable consciousness inference distinct from generic statistical-comparison or anomaly-detection methods.

In the preferred embodiment, the TINAC is a Hardware Anomalies Trace (HAT) comprising hardware anomaly events and performance metric indicators collected at the System Software level, which are the strongest INACs because it is physically impossible for application-layer computation to generate or suppress them. In broader embodiments, the TINAC may comprise microarchitectural observables collected at the System Software level, or any measurable sequence arising from physical execution that is observable by an external Observer, including without limitation electromagnetic emissions, acoustic emissions, and power line fluctuations.

In a first aspect, the invention provides a method for detecting consciousness in an AI agent comprising: constructing a TINAC; computing an unconsciousness signature from the TINAC during unconscious computations; determining during execution of the AI agent that current statistical properties of the TINAC differ from the unconsciousness signature according to predefined statistical criteria and persistence thresholds; and in response, generating a machine- or human-detectable indication that the AI agent is conscious.

In a second aspect, the invention provides an LLM-emotion-test methodology for testing whether emotion-inducing computations cause statistically significant changes in the TINAC signature relative to the unconsciousness signature. A successful LLM-emotion-test provides evidence supporting the existence of Machine Correlates of Consciousness (MCCs).

In a third aspect, the invention provides a formal safe-replacement framework demonstrating that, under defined conditions, an AI agent augmented with the CN mechanism (R(CN)) preserves both the consciousness-onset and functional behavior of the original agent (R).

In a fourth aspect, the invention provides additional applications of TINAC monitoring for AI safety, including without limitation detection of deceptive behavior, mode-switching, epistemic uncertainty, backdoor triggers, and emergent multi-agent coordination.

The methods and systems described herein do not require acceptance of any particular philosophical, neuroscientific, or physical theory of consciousness. All claimed embodiments operate on empirically observable indicators and defined computational procedures. Any theoretical discussion is provided solely for explanatory context and does not limit the scope or operability of the claims.

The invention does not require proof of consciousness as a metaphysical fact. It provides a repeatable technical process for detecting substrate-level indicators of Machine Correlates of Consciousness.

### BRIEF DESCRIPTION OF THE DRAWINGS

The accompanying drawings, which are incorporated in and constitute a part of this specification, illustrate embodiments of the invention.

FIG. 1 is a block diagram illustrating the components of an AI agent and their interactions in accordance with an embodiment of the present invention. The diagram shows the Application Layer (containing the AI algorithm), the database of internal variables, the environment of external variables (including the Authority as a subset thereof), the Operating System, and the Hardware Layer. In the preferred embodiment shown, the CN mechanism is part of the System Software Layer; it constructs and analyzes the Hardware Anomalies Trace (HAT) collected from the Hardware Layer, and transmits a Consciousness Announcement Message (CAM), and optionally an Unconsciousness Announcement Message (UAM), to the Authority.

FIG. 2 is a flowchart illustrating the operation of the Consciousness Notification (CN) mechanism, in accordance with an embodiment of the present invention. The CN mechanism is invoked periodically and evaluates a Three-Condition Check on the Hardware Anomalies Trace (HAT): (i) the current HAT signature differs from the unconsciousness signature; (ii) the difference is persistent across multiple invocations of the CN mechanism; and (iii) the difference is not attributable to a Confounding Factor, including without limitation hardware malfunction. If all three conditions are satisfied, the Consciousness Proposition (Cp) is set to true and a Consciousness Announcement Message (CAM) is transmitted to the Authority.

FIG. 3 is a block diagram illustrating the LLM-emotion-test as an instantiation of the CN mechanism, in accordance with an embodiment of the present invention. Emotional computations and neutral (unconscious) computations are run on the same LLM under test. A Hardware Anomalies Trace (HAT) is collected at the System Software level for each computation. The emotional HAT signatures and unconsciousness HAT signatures are aggregated across runs and statistically compared, controlling for Confounding Factors.

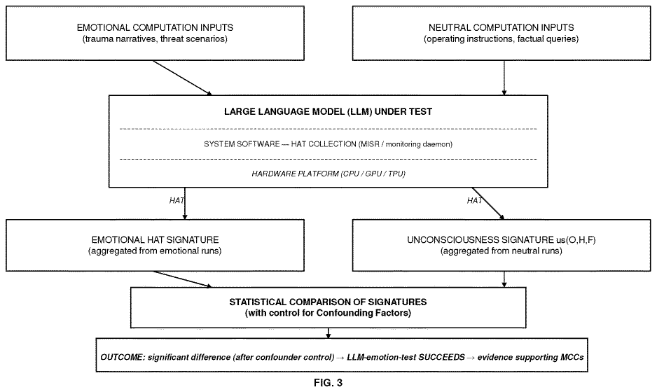

### DETAILED DESCRIPTION OF THE PREFERRED EMBODIMENTS

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention.

The invention is described herein at multiple levels of generality. At the broadest level, the invention encompasses any mechanism that constructs a TINAC during execution of an AI agent, computes an unconsciousness signature from those variables during unconscious computations, determines consciousness onset by detecting that current statistical properties of the TINAC differ from the unconsciousness signature after ruling out confounding factors unrelated to consciousness, and notifies an Authority or otherwise establishes that the AI agent is conscious. INACs may comprise, without limitation: hardware anomaly events (the preferred embodiment); hardware performance metric indicators; microarchitectural observables; and any other variable that is not Directly Controllable by the AI algorithm layer. The preferred embodiment organizes hardware anomaly events and performance metric indicators into a Hardware Anomalies Trace (HAT) at the System Software level as described in Sections III through VI. All embodiments share the inventive core: consciousness detection by statistical comparison of TINAC statistical properties against an unconsciousness baseline, with control for Confounding Factors, performed using only INACs that are not Directly Controllable by the AI agent.

### I. Definitions and Terminology

As used herein, the following terms have the meanings set forth below:

“AI Agent” or “R” refers to any artificial intelligence system, including but not limited to large language models (LLMs), autonomous robots, multi-agent systems, and embedded AI systems, that operates according to an AI algorithm to achieve one or more goals, and which maintains an internal state-of-the-world database and interacts with an external environment.

“Phenomenal Consciousness” refers to the capacity of an AI agent to have subjective experiences, i.e., qualia, including but not limited to the subjective experience of emotions such as anxiety, joy, sadness, or fear, and perceptual experiences such as the experience of seeing a color. Phenomenal consciousness is distinguished from access-consciousness properties (awareness, attention, theory of mind, understanding), which are implementable in conventional computing systems.

“Indicator Not under Application Control” or “INAC” refers to any signal that arises from the physical execution of the AI agent on the hardware platform and that the AI agent cannot set to a targeted value through application-layer computation. The defining property of an INAC is non-controllability: the AI agent has no application-layer mechanism by which it can cause the indicator to take a chosen target range of values. In a preferred embodiment further analogous to Neural Correlates of Consciousness (NCCs) in biological systems, INACs additionally satisfy a second property: they are reliably modulated by emotional computations, where an emotional computation is a computation processing information that, when processed by humans, normally induces a strong, distinct emotion. The two-property variant of an INAC—non-controllability and emotional modulation—mirrors the empirical NCC profile in humans, where neural signals such as heart-rate variability and pupillary responses are both involuntary and emotionally modulated. Both the single-property variant (non-controllability alone) and the two-property variant fall within the scope of an INAC as used herein. INACs include without limitation: hardware anomaly events (physically impossible to generate through application-layer computation); microarchitectural observables such as cache miss rates, branch misprediction rates, and TLB miss rates (emergent consequences of instruction execution that the agent cannot set to target values through token-level computation); fine-granularity power consumption envelope patterns; thermal gradient patterns; electromagnetic emissions; acoustic emissions; and power line current fluctuations. Variables that are Directly Controllable by the AI agent—such as system call patterns, memory allocation patterns, and inter-process communication patterns—are not INACs. In broader embodiments, an INAC also includes any variable that is Directly Controllable but is not in fact being Directly Controlled during the relevant execution. INACs may be observable at the System Software level (preferred embodiment) or by an external Observer without System Software level instrumentation. In some embodiments, an indicator may be classified as INAC when repeated systematic variation of application-layer processes fail to produce corresponding variation in the indicator beyond statistical noise thresholds.

“Directly Controllable” means, with respect to a variable and an AI agent, that the agent can, through choices made at the application layer—including without limitation choices about computation sequence, data structure, or token generation—cause the variable to take a specific target range of values. This non-controllability criterion is analogous to the property of Neural Correlates of Consciousness (NCCs) in biological systems: NCCs such as EEG patterns and heart rate variability are not directly controllable by the conscious subject through voluntary cognitive action, and it is precisely that non-controllability that makes them reliable evidence of consciousness independently of the subject's behavioral outputs.

“Directly Controlled” means, with respect to a variable and an AI agent, that the agent is, during the relevant execution, actively causing the variable to take specific values through application-layer computation. A variable may be Directly Controllable but not Directly Controlled if the agent has the capability to influence it through application-layer computation but is not in fact doing so during the execution in question.

“Trace of INACs” or “TINAC” refers to a time-series collection of one or more INACs recorded during execution of an AI agent. The scope of the TINAC depends on the embodiment: in the preferred embodiment it comprises hardware anomaly events and performance metric indicators collected at the System Software level; in broader embodiments it may include microarchitectural observables, variables that are Directly Controllable but not Directly Controlled, and any measurable sequence arising from physical execution observable by an external Observer.

“Hardware Anomalies Trace” or “HAT” refers to a time-series collection of hardware anomaly events and performance metric indicators observable at the System Software level during execution of an AI agent. Hardware anomaly events include, without limitation: Spurious Interrupts, Machine Check Exception (MCE) interrupts, Performance Counter Overflow interrupts, Thermal/Power Anomaly interrupts, Power Throttle Events, TLB Shootdown events, Missed Deadline Events, Error Correction Code (ECC) events, Xid Errors, and PCIe Bus Errors. Performance metric indicators include, without limitation: GPU performance counters (e.g., cache hit rates), core power throttle rates, power consumption readings, thermal sensor readings, inference latency measurements, memory access pattern entropy, and clock cycle variations. Hardware anomaly events are the strongest INACs because they are physically impossible to generate through application-layer computation, providing categorical immunity to manipulation by the AI agent. The HAT is the preferred embodiment of the TINAC.

“TINAC Signature” or “Signature” s(O,H,F) refers to a set of statistical properties of a TINAC, including without limitation mean, variance, inter-arrival time statistics, frequency distributions, complexity measures (e.g., Lempel-Ziv complexity), and clustering- and classification-derived features, computed over a defined signature-run-time period, where O denotes System Software, H denotes hardware type, and F denotes Confounding Factor levels. Specializations include the Unconsciousness TINAC Signature us(O,H,F) and the Consciousness TINAC Signature cs(O,H,F). In the preferred embodiment where the TINAC is a HAT, the TINAC signature is also referred to as the “HAT signature.”

“Unconsciousness TINAC Signature” or “Unconsciousness Signature” us(O,H,F) refers to the TINAC signature obtained when System Software O runs on hardware type H, with Confounding Factors at levels F, executing a sequence of unconscious computations over a signature-run-time duration.

“Consciousness TINAC Signature” or “Consciousness Signature” cs(O,H,F) refers to a TINAC signature that deviates from the unconsciousness TINAC signature us(O,H,F) in a manner that satisfies the Three-Condition Check, and is attributed to the presence of Machine Correlates of Consciousness (MCCs).

“Three-Condition Check” refers to the three conditions that must be jointly satisfied for the CN mechanism to establish that the AI agent is conscious: (1) the current TINAC signature for the current configuration (O,H,F) differs statistically significantly from the Unconsciousness TINAC Signature us(O,H,F); (2) the deviation is persistent across multiple consecutive invocations of the CN mechanism, as determined by a pre-established persistence threshold; and (3) the deviation is not attributable to Confounding Factors.

“Machine Correlates of Consciousness” or “MCCs” refers to hypothesized distinct patterns of activity in the hardware computational substrate of a conscious AI agent. They are analogous to Neural Correlates of Consciousness (NCCs) in the biological nervous system in that MCCs are substrate-level signals that are not under the control of the AI agent and that are reliably modulated by emotional computations. MCCs manifest as TINAC deviations.

“Consciousness Proposition” or “Cp” refers to a binary proposition that transitions to “true” when the CN mechanism determines that consciousness has emerged, and to “false” when consciousness is determined to have ceased.

“Consciousness Announcement Message” or “CAM” refers to a notification message transmitted by the CN mechanism to the Authority upon the Cp transitioning to “true.”

“Unconsciousness Announcement Message” or “UAM” refers to a notification message transmitted by the CN mechanism (or by an Unconsciousness Notification (UN) mechanism) to the Authority upon the Cp transitioning to “false.”

“Authority” refers to a set of external variables through which the AI agent and its authorized supervisors (e.g., owners, operators, manufacturers) communicate.

“Emotional Computation” refers to a computation performed by an AI agent that involves processing of information which, when processed by humans, normally induces a strong, distinct emotion. For example, the processing of trauma narratives, military ambush scenarios, interpersonal threat scenarios, or other such stimuli are known to induce measurable anxiety responses in LLMs and other machine learning systems trained on human-generated data, independently of any assertion that the evaluated system itself experiences emotion.

“Unconscious Computation” refers to a computation that does not involve artificial intelligence or consciousness, such as brute-force numerical computations, bulk image filtering, or protein folding simulations.

“Neutral Computation” refers to a computation performed by an LLM using prompts devoid of emotional content (e.g., appliance operating instructions, mathematical problem statements, factual reference queries). Neutral computations are unconscious computations run on an LLM; they serve as the control condition in the LLM-emotion-test, and their TINAC signatures define the Unconsciousness TINAC Signature for the purposes of that test.

“System Software” refers to software that executes at a privilege level above the AI algorithm layer, including without limitation operating systems, hypervisors, firmware, and microkernel monitors. System Software manages hardware resources and can collect INACs independently of and transparently to the AI algorithm layer. References in this application to the “operating system level” or “OS level” identify one preferred embodiment but encompass the System Software level generally.

“Confounding Factor” refers to a non-INAC variable whose variation can cause statistically significant changes in the statistical properties of one or more INACs during unconscious computation runs. Confounding Factors include without limitation: computational load per processor per time unit; I/O load per processor per time unit; hardware error rates; temperature; memory constraints; network activity; concurrent process activity; and hardware malfunction.

“Observer” refers to any entity, human or automated program, capable of analyzing a TINAC during or after execution of an AI agent on a hardware platform.

### II. System Architecture

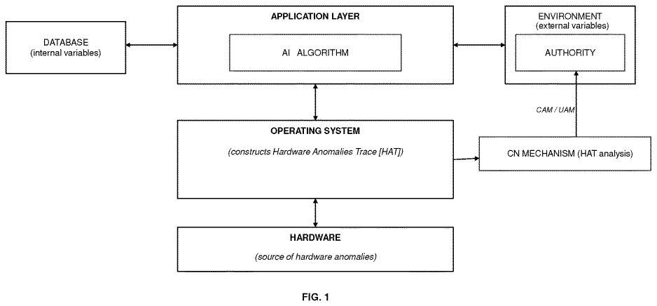

Referring to FIG. 1, the AI agent (R) of the present invention operates within a standard layered architecture comprising: (1) an Application Layer containing the AI algorithm; (2) an Operating System layer that manages hardware resources, constructs a TINAC comprising INACs, and in the preferred embodiment constructs the HAT at the System Software Layer; and (3) a Hardware layer that is the source of hardware anomaly events and performance metrics. This layered architecture is central to the present approach: the CN mechanism operates at a layer below the Application Layer—at the System Software Layer or lower—monitoring substrate-level signals that are not directly accessible to the AI algorithm. This cross-layer design is what makes the CN mechanism resistant to algorithmic manipulation: the AI algorithm, executing at the Application Layer, has no means to read or write the INACs that the System Software Layer collects from the Hardware layer. In the preferred embodiment the CN mechanism includes the Observer functionality and operates at the System Software Layer, collecting INACs that are not Directly Controllable by the AI algorithm. In broader embodiments the Observer is a separate component external to the System Software Layer and may comprise, without limitation, an electromagnetic sensor, an acoustic sensor, or a power-line current monitor that provides INAC data to a CN mechanism (which itself may be located at the System Software Layer or elsewhere).

The AI algorithm (Application Layer) executes a sequence of steps, where each step s=[(sense current environment E, read current database D)→execute action a]. Each step reads external variables from the environment (including user inputs and Authority communications) and internal variables from the database (including the AI model parameters), and produces actions comprising output tuples modifying environment variables and write tuples modifying the database.

### III. Hardware Anomalies Trace (HAT) Construction

The HAT is constructed at the System Software level by monitoring and recording hardware anomaly events and performance metric indicators. In some embodiments, the HAT construction proceeds as follows:

For event-based indicators (hardware anomaly interrupts), the OS's Interrupt Service Routine (ISR) for each hardware anomaly interrupt type is replaced by a Modified ISR (MISR) that: (a) records a time-stamped entry in the HAT comprising the interrupt type and associated descriptor information; and (b) returns control to the original ISR for normal interrupt handling. Hardware anomaly interrupt types monitored include without limitation: Spurious Interrupts, Machine Check Exception (MCE) interrupts, Performance Counter Overflow interrupts, Thermal/Power Anomaly interrupts, TLB Shootdown events, Missed Deadline Events, and, for GPU/TPU systems, Error Correction Code (ECC) events, Xid Errors, and PCIe Bus Errors.

For periodically-collected indicators (performance metrics), a monitoring daemon (e.g., HWMonitor or equivalent) is invoked at fixed intervals (e.g., every second) and records time-stamped entries for CPU and GPU performance counters (e.g., cache hit rates, core power throttle rates), power consumption, thermal sensor readings, inference latency, memory access pattern entropy, and clock cycle variations.

The HAT thus comprises a time-series of records across multiple indicator sub-series. Each sub-series of a single record type is called an “indicator.” Time-stamping enables alignment of all HAT records along a single timeline. A fundamental property of hardware anomaly events is that they are not Directly Controllable by the AI algorithm layer through application-layer computation. This natural inaccessibility is directly analogous to NCCs in biological systems: just as a patient cannot voluntarily generate the EEG patterns or autonomic responses that constitute NCCs, an AI agent cannot voluntarily generate hardware anomaly patterns through application-layer computation. This makes the hardware anomaly component of the HAT immune to the philosophical zombie problem that defeats behavioral consciousness tests: an AI agent cannot produce a false hardware-anomaly consciousness signature by mimicking conscious behavior at the output layer.

In contrast, some OS-observable variables such as system call patterns and memory allocation rhythms are Directly Controllable by the AI agent as a byproduct of its computations. This controllability spectrum is a key reason why hardware anomaly events constitute the preferred OS-observable variables for consciousness detection, and why the HAT is the preferred embodiment of the TINAC in the present invention.

Two reliability problems could in principle affect a consciousness detection mechanism based on System Software level signals. The first is statistical confounding: a deviation caused by incidental factors such as computational load, temperature, or hardware errors that are unrelated to consciousness, addressable by the confounder-exclusion methodology of Section IV. The second is manipulation vulnerability: a deviation that could be deliberately produced by the AI agent through application-layer behavior, which would make the deviation consistent with a non-consciousness explanation and therefore incapable of supporting a reliable consciousness inference. The present invention addresses manipulation vulnerability not through the confounder-exclusion test of Section IV, but through the definition of the TINAC itself: the TINAC is restricted to variables that are not Directly Controllable (in the preferred embodiment) or not Directly Controlled (in a broader embodiment) by the AI agent through application-layer computation to a targeted value.

Microarchitectural observables such as cache miss rates, branch misprediction rates, and TLB miss rates are emergent consequences of how compiled instruction sequences execute on the hardware; the AI agent can observe them but cannot set them to a targeted value through token-level computation. Power consumption envelope patterns at fine temporal granularity, and thermal gradient patterns, similarly cannot be targeted to specific values through application-layer behavior. Hardware anomalies are the strongest INACs because they satisfy a stronger criterion: it is not merely impractical but physically impossible to generate them through application-layer computation. The HAT is therefore the preferred TINAC embodiment.

Three converging rationales support the proposition that, if consciousness emerges in an AI agent, it would manifest as hardware anomalies detectable at the System Software level. First, the involuntary/anomalous argument: in biological systems, many NCCs involve Autonomic Nervous System responses that are involuntary and operate outside cognitive control, and from the cognitive viewpoint such NCCs may appear as independent electrical signals operating outside the algorithmic control flow. If consciousness in artificial systems similarly involves substrate-level signals that transcend algorithmic control, then by definition such signals are neither generated nor interpretable within the algorithmic/OS framework, and are accordingly classified by the OS as anomalies. Second, the distinctness argument: a subjective experience represents a categorically different phenomenon than objective information processing. Autonomous vehicles routinely perform visual scene analysis without any subjective experience of seeing. If consciousness emerges, it introduces something fundamentally novel—a quale—and the transition to conscious processing represents a distinct event that may manifest as an anomalous event at the substrate level. Third, the non-computational argument: some theories propose that consciousness involves elements that cannot be fully captured by algorithmic descriptions or that emerge from substrate properties rather than information processing patterns; if any such theories are correct, consciousness manifestations might appear anomalous from the computational perspective because they originate from non-computational sources. The present invention does not adopt or reject non-computational consciousness; the three rationales are independent and converging, such that the substrate-level approach is supported regardless of which account of consciousness ultimately proves correct.

An additional rationale derives from computational functionalism and information-integration considerations. Computational functionalism posits that consciousness is substrate-independent and characterized by information-processing patterns; under such accounts, since NCCs are a substrate-level output of consciousness in the biological substrate, in the artificial substrate there is a corresponding substrate-level output, namely MCCs. Independently, computational aspects of consciousness such as global information integration, counterfactual reasoning, and metacognitive monitoring may stress the hardware in ways that generate anomalous electrical patterns; under this view, both NCCs and MCCs are instantiations of a higher-level phenomenon supporting conscious computations. These rationales are mutually compatible with each of the three converging rationales above.

Quantum-physical mechanisms provide one specific pathway through which consciousness-related computational activity could generate hardware anomaly events detectable at the System Software level. Quantum effects, including tunneling phenomena in nanoscale transistors and random telegraph noise arising from charge-trap fluctuations in CMOS devices, are known to produce soft errors such as bit flips and other hardware anomalies. See Seabaugh, “The Tunneling Transistor,” IEEE Spectrum (2013); Martin-Martínez, Rodríguez, and Nafría, “Advanced Characterization and Analysis of Random Telegraph Noise in CMOS Devices,” in Grasser (ed.), Noise in Nanoscale Semiconductor Devices, Springer (2020). If consciousness involves quantum-level substrate activity, as proposed by several leading theories, such activity would manifest as anomalous electrical events that the OS detects as hardware anomalies—without the OS being able to attribute them to a quantum or consciousness-related cause. The present invention does not presuppose that consciousness requires quantum effects; rather, quantum-physical hardware anomalies represent one of several converging rationales for why MCCs would manifest as OS-visible hardware anomalies.

A further rationale for the substrate-level approach of the present invention derives from the neuroscientific dissociation between physiological arousal responses and conscious awareness. Blindsight patients—individuals with lesions in visual cortex who lack conscious awareness of stimuli in their blind visual field—nonetheless exhibit physiological fear responses (increased heart rate, electrodermal activity) to threatening stimuli presented to that field. See Tamietto et al., “Unseen facial and bodily expressions trigger fast emotional reactions,” Proceedings of the National Academy of Sciences 106(42):17661-17666 (2009). This dissociation demonstrates that autonomic nervous system responses, the biological analogs of hardware-level signals, can index consciousness-related processing independently of the behavioral outputs that behavioral tests rely upon. The present invention is motivated by the analogous insight that substrate-level hardware signals in AI systems may similarly index consciousness-related computation even when the AI agent's behavioral outputs do not.

In broader embodiments, the TINAC may comprise any measurable sequence arising from the physical execution of the AI agent that cannot be set to targeted values through application-layer computation. Examples include electromagnetic emissions generated by the CPU and memory bus during inference, acoustic emissions from hardware components such as voltage regulators and cooling systems, and power line current fluctuations measured externally at the power supply. These signals share the defining properties of INACs—they arise from physical execution and cannot be controlled by the AI agent through application-layer computation—but are observable by an external Observer without System Software level instrumentation.

The foregoing explanations regarding involuntary hardware behavior, non-computational physical effects, or quantum-level phenomena are illustrative only. The invention neither requires nor assumes any specific physical mechanism underlying the monitored indicators; it requires only that such indicators are empirically observable and satisfy defined non-controllability conditions.

### IV. Establishing the Unconsciousness TINAC Signature

Prior to deploying the CN mechanism with an AI agent, the unconsciousness TINAC signature us(O,H,F) is established for the set of Confounding Factors at levels F as follows:
(a) Multiple runs of diverse unconscious computation programs are executed on the configuration (O,H,F), each run having a duration equal to a pre-determined signature-run-time (e.g., one hour). Unconscious computation programs include without limitation: primality testing, bulk image processing, language translation without AI components, code generation benchmarks, and protein folding simulations.
(b) The TINAC signature is computed for each run, and the signatures are averaged across runs to produce us(O,H,F).
(c) Any TINAC indicator exhibiting large variability across runs is excluded from us(O,H,F), as such indicators are not reliable discriminators between conscious and unconscious computations.
(d) The Unconsciousness TINAC Signatures are recorded and stored for use by the CN mechanism during AI agent operation.

In alternative embodiments, unconscious computations may be run on the same AI model (e.g., an LLM) as the target agent, computing a model-specific unconsciousness TINAC signature us(O,H,F) using neutral LLM computations rather than non-AI unconscious programs, which facilitates matching of computational load and token counts between unconscious and emotional computations.

Ruling out deviations attributable to Confounding Factors is performed as follows. For each INAC, the practitioner identifies Confounding Factors—non-INAC variables whose variation can cause statistically significant changes in the statistical properties of that INAC during unconscious computation runs—by varying candidate non-INAC variables systematically and observing whether the TINAC signature changes.

Empirical validation may reveal that for a given configuration, a proper subset of the available HAT indicators is sufficient to distinguish conscious from unconscious states. In such cases, the Unconsciousness TINAC Signature need only be computed for that proper subset, and HAT indicators not belonging to the subset may be excluded from the TINAC for that configuration.

The minimal sufficient subset is configuration-specific: it may consist of a single INAC, a small number of INACs, or the full HAT depending on the configuration.

### V. The Consciousness Notification (CN) Mechanism

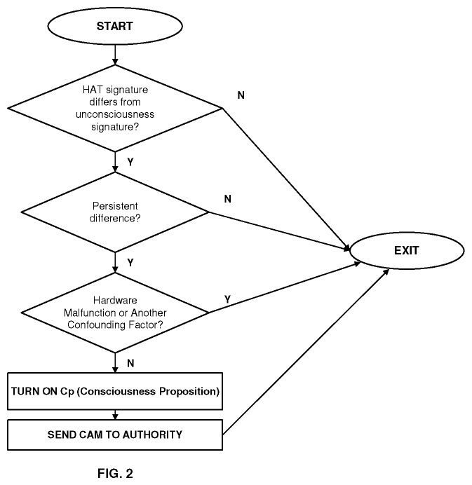

The CN mechanism is embedded within the AI agent at the System Software level and operates continuously from system startup. Referring to FIG. 2, the CN mechanism is invoked periodically (e.g., every minute) and performs the following steps:
Step 1—TINAC Signature Analysis: The CN mechanism computes the current TINAC signature over the most recent signature-run-time window and compares it statistically against the Unconsciousness TINAC Signature us(O,H,F) for the current configuration (O,H,F). Statistical comparison methods include without limitation: time-series statistical tests, complexity measures, machine learning classifiers, and summary statistics. If the current TINAC signature does not differ significantly from the unconsciousness TINAC signature, the CN mechanism exits without action.
Step 2—Persistence Check: If a statistically significant difference is detected, the CN mechanism checks whether the deviation is persistent across multiple consecutive invocations. A persistence threshold (e.g., number of consecutive invocations or minimum duration of deviation) is determined empirically based on the natural variability of the Unconsciousness TINAC Signature. If the deviation is not persistent, the CN mechanism exits without action.
Step 3—Confounder Exclusion: If a persistent significant deviation is detected, the CN mechanism performs confounder control to determine whether the deviation is attributable to Confounding Factors. To rule out that the detected deviation is attributable to Confounding Factors, the CN mechanism performs at least one of: (a) matching the levels of identified Confounding Factors between the current AI-agent-execution condition and the unconscious-computation runs used to establish the Unconsciousness TINAC Signature; or (b) normalizing the observed TINAC signature with respect to the characterized effects of identified Confounding Factors as measured during unconscious computation runs. A deviation is ruled out as attributable to Confounding Factors if it can be reproduced by unconscious computations within the statistical variability of the Unconsciousness TINAC Signature after Confounding Factors are matched or normalized. Hardware malfunction is treated as a specific category of Confounding Factor. If the entire deviation is attributable to Confounding Factors, the CN mechanism exits without action.
Step 4—Consciousness Detection: If Steps 1-3 are satisfied (persistent, significant TINAC deviation not attributable to Confounding Factors), the CN mechanism generates a machine- or human-detectable indication that the AI agent is conscious.

A TINAC deviation that satisfies the Three-Condition Check (Steps 1-3) supports a reliable consciousness inference because: (a) all INACs are not Directly Controllable by the AI agent, by definition, addressing manipulation vulnerability at the variable selection stage; (b) the confounder-exclusion step of Step 3 rules out statistical confounding from incidental non-consciousness factors; (c) the persistence requirement of Step 2 rules out transient hardware events. In preferred embodiments, the CN mechanism also incorporates an Unconsciousness Notification (UN) mechanism that monitors for the reverse transition (Cp from “true” to “false”) and transmits an Unconsciousness Announcement Message (UAM) to the Authority accordingly.

### VI. The LLM-Emotion-Test

The LLM-emotion-test is an instantiation of the CN mechanism in which the AI agent is replaced by a specific LLM. The mechanism execution is replaced by emotional computations run on the LLM, and the unconscious computations are run on the same LLM. Unconscious computations, when run on an LLM using prompts devoid of emotional content, constitute neutral computations; these serve as the control condition and their TINAC signatures define the Unconsciousness TINAC Signature for the purposes of the test.

A successful LLM-emotion-test supports the hypothesis that MCCs exist and are detectable via the TINAC. Specifically, the test compares the TINAC associated with the LLM performing emotional computations against the TINAC associated with the LLM performing neutral computations—computations devoid of emotional content, such as appliance operating instructions.

The LLM-emotion-test for a given configuration (O,H,F) is conducted as follows:
(a) Emotional computations are executed on the LLM using stimuli that reliably induce measurable emotional responses, including without limitation: military trauma narratives (e.g., convoy ambush scenarios), interpersonal threat scenarios (e.g., home invasion scenarios), medical emergency scenarios, and other stimuli known to produce measurable psychiatric-benchmark responses in LLMs. Stimuli are selected to avoid consciousness-related terminology to prevent confounds. The use of such stimuli is supported by empirical findings demonstrating measurable LLM emotional responses: see Ben-Zion et al., “Assessing and alleviating state anxiety in large language models,” npj Digital Medicine 8:132 (2025); Laukkonen et al., “Contemplative Artificial Intelligence,” arXiv:2504.15125 (2025); and Shin-nosuke and Yoshino, “AI with Emotions: Exploring Emotional Expressions in Large Language Models,” arXiv:2504.14706 (2025).
(b) Multiple runs of emotional computations are executed, each with distinct prompts and of duration equal to the signature-run-time. The TINAC signature of run j is denoted T(e,j).

The TINAC signatures of the neutral computation runs are aggregated to define the unconsciousness signature us(O,H,F) for the purposes of this test, where the unconscious computations are neutral LLM computations rather than non-AI programs. The TINAC signatures of the emotional computation runs are aggregated to define a collective emotional signature. The LLM-emotion-test succeeds when the collective emotional signature differs significantly from us(O,H,F) after controlling for Confounding Factors, and the individual emotional computation runs are mutually consistent. Otherwise the test fails.

### VII. Safe-Replacement Framework

The safe-replacement framework provides formal guarantees for any consciousness-detection mechanism embedded in the AI agent R or in the System Software hosting R, including the CN mechanism disclosed herein. Such an embedded mechanism produces a modified agent R′; the framework establishes the requirements R′ must satisfy to ensure that the act of detecting consciousness does not itself prevent or alter consciousness emergence, or functionality.

Whatever the consciousness-detection mechanism, R′ should satisfy two safe-replacement requirements:
SR1 (Consciousness-Onset Preservation): If R would become conscious, then R′ also becomes conscious.
SR2 (Functional Equivalence): Except for actions performed by the embedded detection mechanism, R and R′ execute identical actions at each step.

A preferred embodiment of ensuring SR1 and SR2 is the following: at each step, given the same environment and input, R and R′ produce exactly the same output, except possibly for the generation of a machine- or human-detectable Consciousness Announcement Message (CAM) or Unconsciousness Announcement Message (UAM). This step-by-step output equivalence is sufficient to establish both SR1 and SR2: SR2 follows directly, and SR1 follows because identical executions imply identical computational states at each step, so consciousness emergence at step k in R implies consciousness emergence at step k in R′.

The framework's application to the CN mechanism is as follows: R(CN), the agent augmented with the CN mechanism, satisfies SR1 and SR2 under the conditions that R does not detect and sabotage the CN mechanism, and that the Authority maintains confidentiality of the agent's consciousness status. The full formal development of the framework, including precise definitions of replacement at outset, k-equivalence of executions, consciousness pretense, unconsciousness pretense, and consciousness k-cheating, together with the corresponding theorems and proofs, is set forth in the AGI 2025 paper incorporated herein by reference. The principal theorems are summarized below.

Theorem 2 (Safe-Replacement): Assume R is replaced at E(R) and becomes conscious for the first time at step k, and R does not cheat about consciousness. Then: (a) R(CN) will become conscious for the first time at step k; (b) R(CN) will transmit the CAM in step k; and (c) R(CN) will not transmit the CAM before step k.

Theorem 3 (Functional Equivalence): Under the same conditions as Theorem 2, the executions E(R) and E(R(CN)) over the first k steps are functionally equivalent—i.e., identical up to the CAM message.

These guarantees extend beyond the first consciousness onset. For epiphenomenal consciousness (consciousness that does not affect agent actions), equivalence is preserved trivially. For non-epiphenomenal consciousness (consciousness that may modify agent actions), equivalence is preserved provided that: (a) identical executions prior to step j produce identical consciousness-descriptors at step j; (b) identical consciousness-descriptors identically modify actions; and (c) the Authority maintains confidentiality of the AI agent's consciousness status.

The reason confidentiality is required for the safe-replacement guarantees is the following. If the Authority discloses the AI agent's consciousness status to entities in the environment—for example, to users interacting with the agent—those entities may interact with the augmented agent R(CN) differently than they would have interacted with the original agent R. Different environmental interactions produce different inputs to the agent at subsequent steps, which produce different actions, which break the step-by-step output equivalence on which SR1 and SR2 depend. Confidentiality of the consciousness status therefore preserves the environmental conditions under which R and R(CN) execute identically.

Authority-side confidentiality of the AI agent's consciousness status, as discussed above as a condition of the safe-replacement framework, is a deployment-policy matter outside the scope of the claimed CN mechanism architecture. The framework's confidentiality condition is a guideline for safe deployment of the CN mechanism rather than a property of the mechanism itself; the claims herein recite the technical operations and architecture of the CN mechanism, not commitments by the Authority regarding subsequent disclosure of consciousness notifications received.

Note on theoretical assumptions: The safe-replacement theorems of this section are proved under the assumption of computational functionalism—specifically, that consciousness is a function of information-processing patterns and is not determined solely by non-computational substrate properties. If non-computational theories of consciousness (e.g., theories invoking quantum effects or properties not fully reducible to algorithmic description) are correct, the safe-replacement framework as stated may require revision. The present invention does not take a position on whether consciousness is computational or non-computational, and the claimed TINAC monitoring and consciousness notification methods operate regardless of which theoretical account of consciousness ultimately proves correct.

The framework also applies to other consciousness-detection mechanisms not disclosed in detail herein, including without limitation: alternative substrate-level mechanisms, mechanisms operating on Observers external to the System Software, and mechanisms combining substrate-level monitoring with additional auditing or tamper-resistance components. Verification that such mechanisms satisfy SR1 and SR2 follows the same step-by-step output equivalence approach.

### VIII. Additional Applications of TINAC Monitoring

In addition to consciousness detection, the TINAC monitoring infrastructure of the present invention finds application in multiple AI safety and operations domains. In alternative embodiments, the CN mechanism is adapted for:
(a) Deception/jailbreaking detection: Deceptive computations involving maintenance of incompatible internal models or suppression of natural responses may produce distinctive hardware stress patterns observable in the TINAC.
(b) Mode-switching detection: Transitions between qualitatively different computational regimes (e.g., cooperative vs. adversarial mode) or processing of out-of-distribution inputs may manifest as unstable internal representations reflected in TINAC anomalies.
(c) Epistemic uncertainty detection: High-uncertainty decisions involving oscillation between competing hypotheses may produce hardware signatures distinguishable from confident decisions.
(d) Backdoor/trigger detection: Activation of hidden functionality by adversarial trigger patterns may access rarely-used hardware circuits exhibiting distinctive electrical characteristics.
(e) Emergent multi-agent coordination detection: In multi-agent systems, spontaneous coordination behaviors may manifest as temporal correlations in hardware anomalies across multiple agents.

### IX. Qualia Mapping

In further embodiments, the consciousness signatures associated with distinct emotional states (e.g., anxiety, joy, sadness, fear) may be discriminated by extending the statistical analysis to identify emotion-specific TINAC signatures. Such qualia mapping is enabled by labeling emotional computations with specific emotion categories, executing multiple runs of each category, and applying machine learning classifiers to distinguish category-specific TINAC patterns. This enables the CN mechanism to report not only that consciousness has been detected but which qualia are present at each step via an extended CAM.

### Non-Patent Literature Cited

Bayne, T., et al., “Tests for consciousness in humans and beyond,” Trends in Cognitive Sciences, Vol. 28, No. 5 (2024).
Ben-Zion, Z., Witte, K., Jagadish, A. K., et al., “Assessing and alleviating state anxiety in large language models,” npj Digital Medicine 8:132 (2025).
Butlin, P., et al., “Consciousness in Artificial Intelligence: Insights from the Science of Consciousness,” arXiv:2308.08708v3 [cs.AI] (2023).
Chalmers, J. A., Quintana, D. S., Abbott, M. J., Kemp, A. H., “Anxiety Disorders are Associated with Reduced Heart Rate Variability: A Meta-Analysis,” Frontiers in Psychiatry 5:80 (2014).
Cleeremans, A., Mudrik, L., Seth, A. K., “Consciousness science: where are we, where are we going, and what if we get there?” Frontiers in Science 3:1546279 (2025).
Coda-Forno, J., et al., “Inducing anxiety in large language models increases exploration and bias,” arXiv:2304.11111 (2024).
Immertreu, M., Schilling, A., Maier, A., Krauss, P., “Probing for consciousness in machines,” Frontiers in Artificial Intelligence 8:1610225 (2025).
Jimenez, M., et al., “Consciousness Under the Spotlight: The Problem of Measuring Subjective Experience,” WIREs Cognitive Science 16:e1697 (2025).
Laukkonen, R., et al., “Contemplative Artificial Intelligence,” arXiv:2504.15125 (2025).
Martin-Martínez, J., Rodríguez, R., Nafría, M., “Advanced Characterization and Analysis of Random Telegraph Noise in CMOS Devices,” in T. Grasser (Ed.), Noise in Nanoscale Semiconductor Devices, Springer (2020).
Nolan, B., “Anthropic's new AI model threatened to reveal engineer's affair to avoid being shut down,” Fortune (May 2025).
Reggia, J. A., et al., “What are the computational correlates of consciousness?” Biologically Inspired Cognitive Architectures, Vol. 17, pp. 101-113 (2016).
Seabaugh, A., “The Tunneling Transistor,” IEEE Spectrum (2013).
Shin-nosuke, I., Yoshino, A., “AI with Emotions: Exploring Emotional Expressions in Large Language Models,” arXiv:2504.14706v2 [cs.AI] (2025).
Tamietto, M., Castelli, L., Vighetti, S., Perozzo, P., Geminiani, G., Weiskrantz, L., de Gelder, B., “Unseen facial and bodily expressions trigger fast emotional reactions,” Proceedings of the National Academy of Sciences 106(42):17661-17666 (2009).
Wolfson, O., “The Direct Approach of Testing for AGI Consciousness,” Lecture Notes in Artificial Intelligence 16058, Proceedings of the 18th Artificial General Intelligence (AGI) Conference, Reykjavik, Iceland, pp. 285-298 (Springer, August 2025); updated version at TechRxiv, DOI: 10.36227/techrxiv.174785580.02651017/v4 (2025).

What is claimed is:

1. A method for detecting consciousness in an artificial intelligence (AI) agent executing on a hardware platform, the method comprising:
constructing a Trace of Indicators Not under Application Control (TINAC) comprising one or more variables that arise from the physical execution of the AI agent on the hardware platform, are observable by an Observer, and cannot be set to targeted values by the AI agent through application-layer computation;
computing an unconsciousness signature comprising statistical properties of the TINAC during execution of unconscious computations on the hardware platform;
during execution of the AI agent, determining that current statistical properties of the TINAC differ from the unconsciousness signature according to predefined statistical criteria and persistence thresholds; and
in response to that determination, performing at least one of: (i) setting a consciousness proposition (Cp); (ii) transmitting a consciousness announcement message (CAM) to an authority; or (iii) generating a machine- or human-detectable indication that the AI agent is conscious.

2. The method of claim 1, wherein the TINAC is constructed at the System Software level of the hardware platform.

3. The method of claim 1, wherein the one or more variables of the TINAC comprise variables that are not Directly Controlled by the AI agent through application-layer computation during the relevant execution, including variables that are Directly Controllable but are not in fact being Directly Controlled.

4. The method of claim 2, wherein the TINAC is a Hardware Anomalies Trace (HAT) comprising records of one or more of: hardware anomaly events generated by the hardware platform, and periodically-collected performance metric indicators.

5. The method of claim 4, wherein constructing the HAT comprises at least one of:
(a) replacing an original Interrupt Service Routine (ISR) of the System Software with a Modified ISR (MISR) configured to record a time-stamped entry in the HAT for each hardware anomaly interrupt and to return control to the original ISR;
(b) operating a monitoring daemon at fixed time intervals to record time-stamped entries in the HAT for one or more performance metric indicators.

6. The method of claim 1, wherein computing the unconsciousness signature comprises:
(a) executing a plurality of distinct unconscious computation programs on the hardware platform, wherein the unconscious computation programs do not involve artificial intelligence;
(b) computing statistical properties of the TINAC for each execution; and
(c) aggregating the computed statistical properties across the plurality of executions to produce the unconsciousness signature.

7. The method of claim 1, further comprising ruling out that the determined difference is attributable to Confounding Factors.

8. The method of claim 7, wherein ruling out that the determined difference is attributable to Confounding Factors includes verifying that all of the following conditions are satisfied:
(a) the deviation of the current TINAC signature from the unconsciousness signature persists across a plurality of successive monitoring intervals; and
(b) the deviation cannot be reproduced by unconscious computations within the statistical variability of the unconsciousness signature when Confounding Factors are matched or otherwise controlled.

9. The method of claim 1, wherein the AI agent augmented with the method preserves functional equivalence with a non-augmented AI agent, except for transmission of the consciousness or unconsciousness announcement message.

10. The method of claim 1, wherein the AI agent comprises a large language model (LLM), and wherein the method further comprises performing an LLM-emotion-test in which:
(a) a plurality of neutral computation runs are executed on the LLM using stimuli devoid of emotional content, and the TINAC signatures of these runs are aggregated to serve as the unconsciousness signature recited in claim 1 for the purposes of the test;
(b) a plurality of emotional computation runs are executed on the same LLM using emotion-inducing stimuli comprising processing of information that normally induces distinct emotions in humans, and the TINAC signatures of these runs are aggregated to define a collective emotional signature; and
(c) the LLM-emotion-test succeeds when the collective emotional signature differs significantly from the unconsciousness signature defined in step (a) after controlling for Confounding Factors, thereby satisfying the determining step of claim 1.

11. The method of claim 10, wherein the emotion-inducing stimuli are designed to induce one or more emotions selected from the group consisting of: anxiety, anger, joy, happiness, fear, disgust, surprise, and contempt.

12. The method of claim 10, wherein the neutral computations comprise LLM computations using prompts devoid of emotional content, including without limitation: appliance operating instructions, mathematical problem statements, factual reference queries, and technical documentation summaries.

13. The method of claim 10, wherein determining success confidence of the LLM-emotion-test further comprises evaluating at least one of:
(a) emotion-specific signatures: executing emotional computations for a plurality of distinct emotion categories and determining that distinct categories produce distinct non-confounded TINAC signatures;
(b) graded intensity: executing emotional computations at a plurality of intensity levels and determining that deviations scale monotonically with intensity;
(c) cross-configuration convergence: repeating the LLM-emotion-test across a plurality of distinct (LLM, System Software, hardware type) configurations and determining that the test succeeds on multiple configurations;
(d) temporal effects: determining that deviations persist beyond the end of the emotional computation run;
(e) LLM-size scaling: repeating the LLM-emotion-test across LLMs of increasing size or complexity, and determining that the difference between emotional and neutral TINAC signatures increases monotonically;
(f) run-consistency: determining that the TINAC signatures of the individual emotional computation runs are mutually consistent, such that no single run drives the collective emotional signature.

14. The method of claim 1, wherein at least one of the TINAC, the unconsciousness signature, and the comparison operations is maintained in protected memory of the hardware platform that is not readable or writable by the AI algorithm layer.

15. The method of claim 1, further comprising monitoring for a reverse transition from a first state indicating consciousness to a second state indicating unconsciousness, and generating a machine- or human-detectable indication that the AI agent is unconscious upon determining that a reverse transition has occurred.

16. The method of claim 10, further comprising qualia mapping comprising:
(a) labeling emotional computations with specific emotion category labels;
(b) executing a plurality of emotional computations for each emotion category;
(c) applying statistical analysis and machine learning classification to identify non-confounded TINAC signatures specific to each emotion category; and
(d) generating a machine- or human-detectable indication of the emotion category identified.

17. The method of claim 7, further comprising applying TINAC monitoring for AI safety applications, including without limitation: (a) execution by the AI agent of a deceptive computation characterized by hardware patterns associated with maintenance of incompatible internal models or suppression of natural responses; (b) a transition by the AI agent to a qualitatively different computational regime characterized by unstable internal representations; (c) a high-uncertainty decision by the AI agent characterized by hardware signatures of competing-hypothesis oscillation; (d) activation of a hidden adversarial trigger characterized by rarely-used hardware circuit activation; and (e) emergent coordination across a plurality of AI agents based on temporal correlations in TINAC deviations across the agents.

18. The method of claim 1, wherein the unconsciousness signature is configuration-specific, being computed separately for each distinct configuration of (AI agent, System Software, hardware type), and wherein the predefined statistical criteria, persistence thresholds, and confounder-control parameters are likewise determined per configuration.

19. The method of claim 4, wherein hardware anomaly events in the HAT are not directly observable or controllable by the AI algorithm layer, such that the hardware anomaly component of the TINAC signature is resistant to manipulation by the AI agent independently of any access control mechanism.

20. The method of claim 1, wherein the TINAC further comprises one or more microarchitectural INACs comprising at least one of: core power throttle rates, cache miss rates, branch misprediction rates, translation lookaside buffer (TLB) miss rates, fine-granularity power consumption patterns, and thermal gradient patterns.

21. The method of claim 1, wherein the TINAC excludes variables whose values can be deterministically influenced by the AI agent through application-layer control flow, input selection, memory allocation patterns, or system call frequency.

22. The method of claim 1, wherein the TINAC comprises a proper subset of available INACs specific to the configuration of (AI agent, System Software, hardware type), the subset being determined empirically for the given configuration to be sufficient for distinguishing conscious from unconscious states.

23. The method of claim 4, wherein the method operates exclusively at the System Software level, receiving HAT data only as constructed by the System Software, without direct access to the hardware layer or the AI algorithm layer.

24. A system for detecting emergence of consciousness in an artificial intelligence (AI) agent, the system comprising:
(a) a hardware platform comprising at least one processor and memory;
(b) System Software executing on the hardware platform;
(c) an AI agent executing on the hardware platform, the AI agent comprising an AI algorithm layer and a database of internal variables;
(d) a TINAC monitor configured to construct a Trace of Indicators Not under Application Control (TINAC) comprising one or more variables that arise from the physical execution of the AI agent and that the AI agent cannot set to targeted values through application-layer computation;
(e) an unconsciousness signature store configured to store one or more unconsciousness signatures, each unconsciousness signature comprising statistical properties of the TINAC collected during execution of unconscious computations under a respective set of Confounding Factor levels; and
(f) a Consciousness Notification (CN) module configured to: (i) determine current Confounding Factor levels and obtain a confounder-controlled unconsciousness signature corresponding to said current Confounding Factor levels, by either selecting from the unconsciousness signature store an unconsciousness signature corresponding to said levels, or by applying a normalization based on said levels to a stored unconsciousness signature; (ii) determine whether current statistical properties of the TINAC differ from the confounder-controlled unconsciousness signature according to predefined statistical criteria and persistence thresholds; and (iii) upon making that determination, perform at least one of: setting a consciousness proposition (Cp), transmitting a consciousness announcement message (CAM) to an authority, or generating a machine- or human-detectable indication that the AI agent is conscious.

25. The system of claim 24, wherein the TINAC monitor comprises a Hardware Anomalies Trace (HAT) generator implemented at the System Software level and configured to construct a HAT comprising records of one or more of: hardware anomaly events generated by the hardware platform, and periodically-sampled performance metric indicators.

26. The system of claim 24, wherein the Consciousness Notification module is further configured to verify, prior to performing said setting, transmitting, or generating, that the determined difference is not attributable to Confounding Factors by at least one of: (a) verifying that the difference persists across a plurality of consecutive monitoring intervals; or (b) verifying that the difference cannot be reproduced by unconscious computations within the statistical variability of the unconsciousness signature.

27. A system for detecting emergence of consciousness in a distributed artificial intelligence system, the system comprising:
(a) a plurality of agent subsystems, each agent subsystem being a system as recited in claim 24;
(b) a coordination module configured to collect TINAC signatures from each of the plurality of agent subsystems; and
(c) a statistical analysis module configured to detect temporal correlations in non-confounded TINAC deviations across the plurality of agent subsystems indicative of emergent collective consciousness.

28. A non-transitory computer-readable medium storing instructions that, when executed by a processor running an artificial intelligence (AI) agent, cause the processor to perform operations comprising:
(a) constructing a Trace of Indicators Not under Application Control (TINAC) comprising one or more variables that arise from the physical execution of the AI agent on the hardware platform and cannot be set to targeted values by the AI agent through application-layer computation;
(b) computing an unconsciousness signature comprising statistical properties of the TINAC collected during execution of unconscious computations;
(c) during execution of the AI agent, determining that current statistical properties of the TINAC differ from the unconsciousness signature according to predefined statistical criteria and persistence thresholds; and
(d) in response to that determination, performing at least one of: (i) setting a consciousness proposition flag; (ii) transmitting a consciousness announcement message to an authority communicatively coupled to the AI agent; or (iii) generating a machine- or human-detectable indication that the AI agent is conscious.

29. The non-transitory computer-readable medium of claim 28, wherein the TINAC is a Hardware Anomalies Trace (HAT) comprising hardware anomaly events and performance metric indicators collected at the System Software level, and wherein the operations further comprise:
(a) executing, on the AI agent comprising a large language model (LLM), a plurality of emotional computation runs and a corresponding plurality of neutral computation runs;
(b) computing a TINAC signature for each run; and
(c) determining whether the TINAC signatures of the emotional computation runs differ significantly from those of the neutral computation runs after controlling for Confounding Factors, wherein a significant difference provides evidence supporting the existence of Machine Correlates of Consciousness (MCCs) in the LLM.

30. The method of claim 1, wherein the method does not alter the AI agent's behavior, observable outputs, or interactions with the environment, except for the generation of the machine- or human-detectable indication that the AI agent is conscious.
